(19) United States
(12) Patent Application Publication
(10) Pub. No.: US 2024/0229977 A1
(43) Pub. Date: Jul. 11, 2024

(54) TRAILER HOSE CARRIER TUBE LINER

(71) Applicant: Brian Wayne Cannon, Elkton, KY (US)

(72) Inventor: Brian Wayne Cannon, Elkton, KY (US)

(21) Appl. No.: 18/528,743

(22) Filed: Dec. 4, 2023

Related U.S. Application Data
(60) Provisional application No. 63/429,934, filed on Dec. 2, 2022.

(51) Int. Cl. F16L 9/00

(52) U.S. Cl. CPC F16L 9/00

(57) ABSTRACT

A liner for hose carrying tubes fitted to semi-trailers to decrease friction and physical effort of transport personnel required for removal and insertion of the removable hoses from the hose carrying tubes fitted on trailers used for transfer of liquid or pneumatically conveyed material transported in the trailers.

This application claims priority from U.S. Provisional Application 63/429,934 filed on Dec. 2, 2022 which is incorporated by reference in its entirety.

### TECHNICAL FIELD OF THE INVENTION

This invention relates generally to a liner for hose carrying tubes fitted to semi-trailers to decrease friction during insertion and removal of hoses therefrom.

### BACKGROUND OF THE INVENTION

The present invention is specific for lined hose carrying tubes on transport trailers which contain hoses that must be removed from the hose carrying tubes and connected to the trailer to transfer product from the trailer to a holding tank such as silo containing plastic pellets.

In the United States, companies spend over one billion dollars a week on worker compensation claims. One major cause is for shoulder injuries. The instant invention provides a solution to help prevent shoulder injuries in the pneumatic and tanker truck transport industries. These workers are required to remove one or more hoses on a daily basis from hose tube carriers mounted onto semi-trailers and connect the hoses to the rear, side, or bottom discharge ports on the trailers to pump fluids or pneumatically convey flow materials such as powders, granular material, or pellets. These hoses are typically two to four inches in diameter and as long as the semi-trailer or tank truck, often 10 to 60 feet in length or an effective length. A plurality of hoses may be connected end to end to provide the necessary length. The hose carrier tubes typically comprises a pipe or pipe rack including a plurality of hose carrying tubes fabricated from metal of a larger diameter than the hose carried therein, and typically one to four inches larger in diameter to facilitate hoses which may have a slight curvature or end connectors. They are typically fitted with quick connect couplings and are attached together to provide the required length to transfer the material from the truck to the holding tank, silo, or receiving container. The hoses are typically multi-ply construction and heavy often weighing between twenty to fifty pounds or more. The driver must pull the hoses out of hose carrying tubes fitted to the frame of the trailer. Due to the height of the trailers typically at least four feet high, the hose tubes are fitted about four to eight feet off of the ground and usually around shoulder height of the workers. The worker must pull these long hoses from the tubes often above their head from an awkward position maximizing the strain on their shoulders.

### SUMMARY OF THE INVENTION

The present invention comprises a polymeric liner disposed within the hose carrier tube or a low friction coating that allows the hose to slide from the hose carrier tube more easily than a conventional metal surface of a hose carrying tube reducing the strain on the worker. A liner for hose carrying tubes is fitted to hose carrying tubes of semi-trailers to decrease friction and physical effort of transport personnel required for removal and insertion of the hoses from the hose carrying tubes fitted on trailers used for transfer of liquid or pneumatically conveyed material transported in the trailers.

It is an object of the present invention to provide a hose carrying tube liner whereby installation can be done by one person using simple hand tools.

It is another object of the present invention to provide a hose carrying tube liner comprising a sleeve disposed within and affixable to the internal surface of a hose carrier tube.

It is another object of the present invention to provide a hose carrier tube liner which protects the hose carrier tube and the hose from wear and tear.

It is another object of the present invention to provide a polymeric non-sticking surface to prevent the hose from freezing to the hose carrier tube surface in freezing weather.

It is another object of the present invention to reduce injuries associated with insertion and removal of hoses from the hose tubes.

It is an object of the present invention to provide a low friction coating or low friction polymeric sleeve for applying to the interior surface of a hose carrier tube to minimize friction between a rubber hose and the hose carrier tube.

It is another object of the present invention to provide a low friction coating or polymeric sleeve extending a selected portion from a selected distal end of said hose carrier tube inward and effective length to reduce friction between said hose and said hose carrier tube.

It is another object of the present invention to provide a hose tube carrier liner having at least one flanged distal end affixed to a distal end of the hose carrier tube.

It is another object to provide a polymeric sleeve or a low friction coating which is self lubricating having a non-stick surface.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a distal end view of hose carrier tube mounting to a trailer;

FIG. 2 is a perspective end view of a flared hose tube liner disposed in a hose carrier tube and affixed to an inner bottom surface thereof and a hose resting on the inner surface of the hose tube liner;

FIG. 3 shows a trailer having a plurality of hose carrier tubes mounted in vertical alignment beside the tank above the wheels;

FIG. 4 shows a trailer having a plurality of hose carrier tubes mounted in vertical alignment beside the tank above the trailer frame above the wheels;

FIG. 5 shows a rear end of a trailer having a hose discharge pipe discharging fluid and a flexible hose having a quick connect fitting for cooperative engagement with the discharge pipe;

FIG. 6 shows cooperative engagement between a transfer hose having a quick connect coupling and a discharge pipe;

FIG. 7 is a perspective view of a quick connect transfer hose having a rubber coating;

FIG. 8 is a perspective view of an embodiment of the present invention showing a hose within a tube liner sleeve disposed within a hose carrier tube;

FIG. 9 shows a flexible fuel oil transfer hose having a rubberized coating; and

FIG. 10 shows a flexible bulk material transport hose having a rubberized coating.

### DETAILED DESCRIPTION OF THE PREFERRED EMBODIMENT

A liner for hose carrying tubes fitted to semi-trailers to decrease friction and physical effort of transport personnel required for removal and insertion of the removable hoses from the hose carrying tubes fitted on trailers used for transfer of liquid or pneumatically conveyed material transported in the trailers.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of ±10%.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

For the purposes of promoting an understanding of the principles of the invention, reference will now be made to the embodiment illustrated in the drawings and specific language will be used to described the same. It will nevertheless be understood that no limitation of the scope of the invention is thereby intended, such alterations and further modifications in the illustrated device, and such further applications for the principles of the invention as illustrated therein being contemplated as would normally occur to one skilled in the art to which the invention relates.

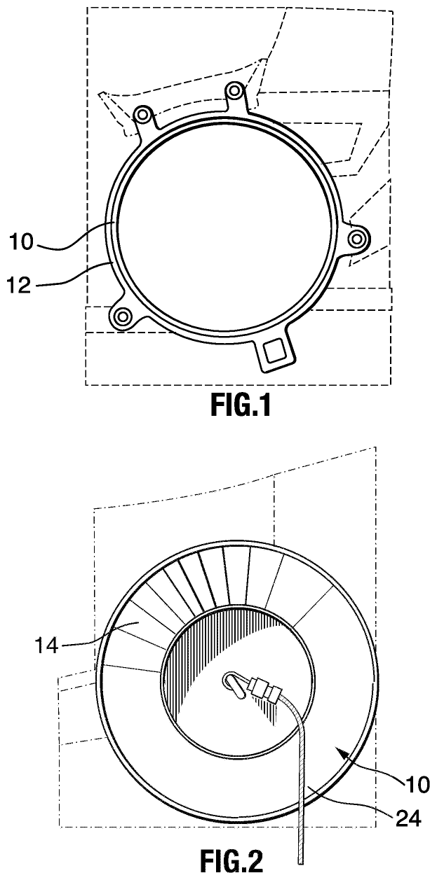

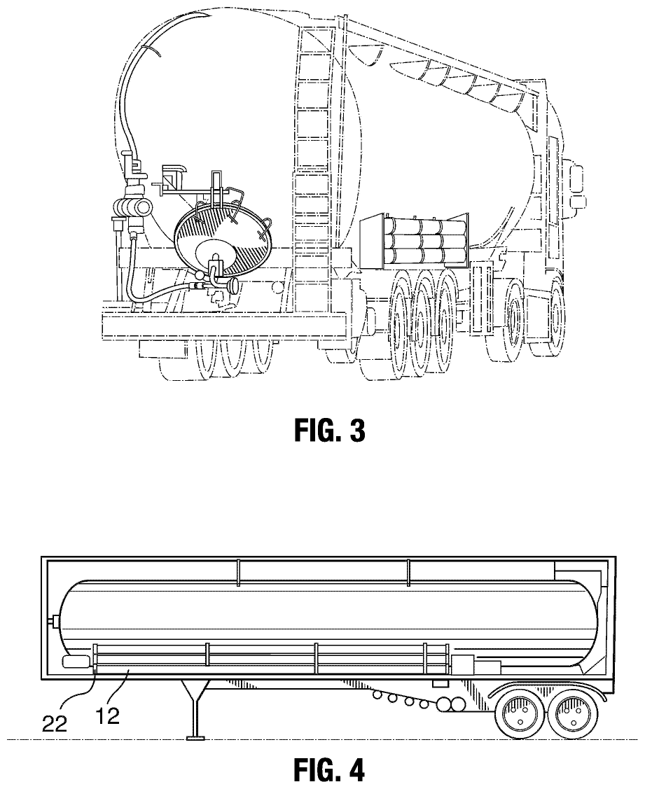

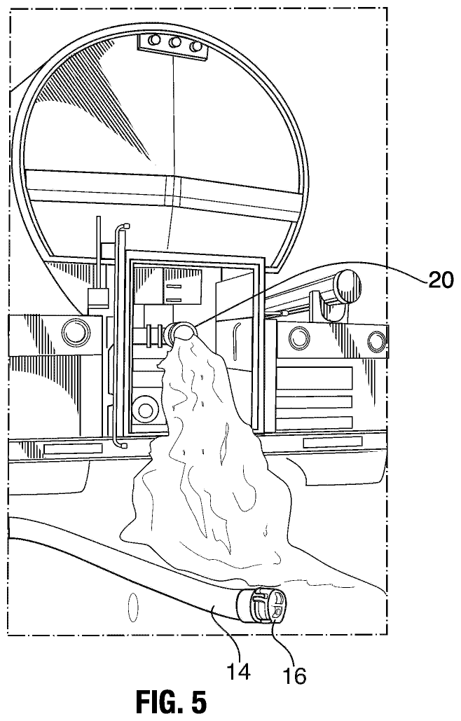

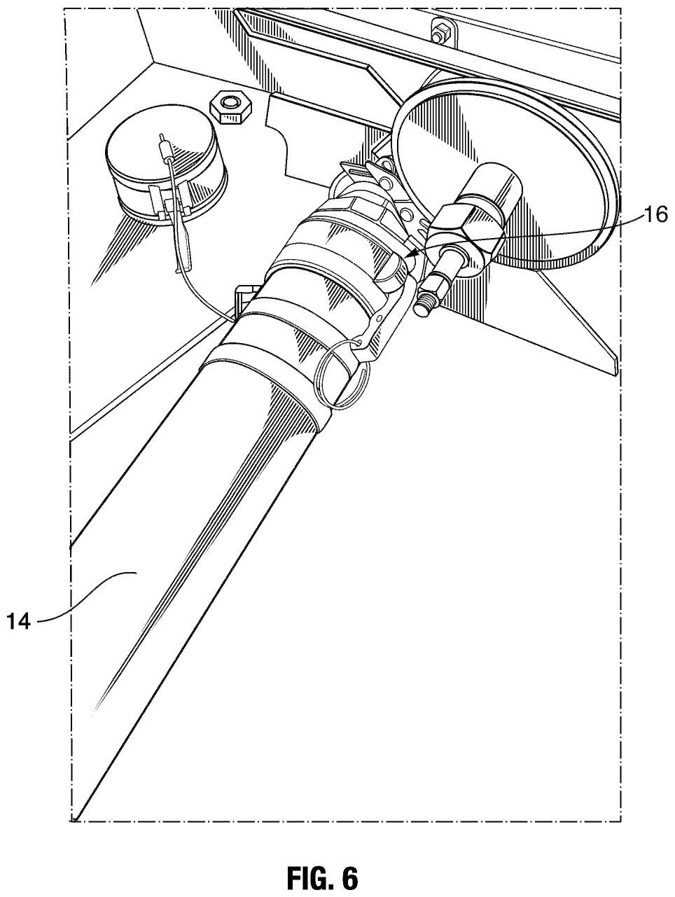

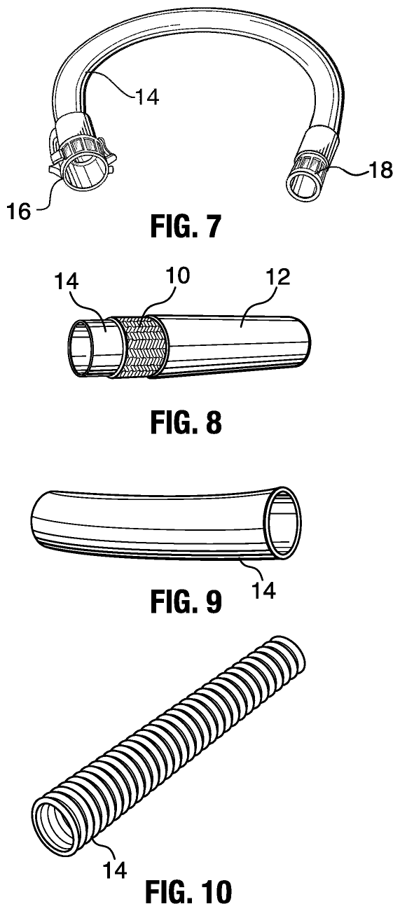

As shown in FIGS. 1-10, the present invention comprises a hose tube liner 10 disposed within the hose carrier tube 12 that allows the hose 14 to slide from the tube more easily reducing the strain on the worker. The hose tube liner for hose carrying tubes is fitted to semi-trailers to decrease friction and physical effort of transport personnel required for removal and insertion of the hoses from the hose carrying tubes fitted on trailers used for transfer of liquid or pneumatically conveyed material transported in the trailers. It is affixed to the frame of a trailer by bolts and typically includes an end cap 22 on opposing ends. It may be mounted in a stacked vertical arrangement.

The hose carrier tube 12 generally comprises steel, fiberglass, stainless steel, TIGER FLEX corrugated polyvinylchloride tubing, or aluminum.

The hoses 14 generally comprise a polymer or polymer blend with fiber and/or steel reinforcement and may include a rubber, elastomer, polyblend or other flexible polymer outer coating or outer layer which often tends to be a high friction type of material. The hose may include end caps and/or couplings 16, 18 for cooperative engagement with the trailer discharge port 20, receiver ports, or additional hoses.

The hose liner can comprise a synthetic material having a low friction surface compared to the conventional inner surface of a hose carrier tube, comprising of a low friction coating or a polymeric material, for example, a polyvinyl chloride material, polyethylene, nylon, or other polymers including ABS, CA, EVA, LCP, LDP, EPA, PA666, PBT, PC, PCT, PE, HDPE, TEFLON, HMWPE, and UHMWPE.

The hose liner may be an effective thickness typically ranging from 1 mm for a disposable sleeve affixed to the inner surface of the hose tube with an adhesive to 1 inch thick if formed from a polymer such as a gas filled polymer or solid polymer. It is contemplated that the tube liner could comprise a thin film or compressible polymer so long as the inner surface contacting the hose is composed of a lower friction material than the tube hose so that the hose slides more easily thereover. It is contemplated that a tube hose liner could comprise a tubular film packaged as a roll, wherein the tube liner could be unrolled and inserted into a hose tube and affixed thereto for a temporary lining. As shown in FIG. 2, a hose tube liner 10 having a flared distal end 24 is disposed within a hose tube carrier 12.

The hose liner may 10 may comprise or consist of a coaxial tube having a low friction interior surface defining a circumferential sleeve as shown in FIG. 8 inserted into and affixable to the internal surface of a hose carrier tube.

### Method of Installation of Hose Tube Liner Sleeve

Installation of the tube hose liner in a tube hose can be accomplished by one person using simple hand tools in five to ten minutes. The tube hose liner should be sized and shaped to conform to the size and shape of the inner diameter of the hose tube contiguous therewith. First the hose is removed from the hose tube and any debris is cleaned from the hose tube. To install a hose tube trough liner, insert one side of the liner into the hose tube and push evenly to prevent the liner from becoming tangled. After the liner is fully inserted into the hose tube, a bit can be used to pre-drill hoes at the end of the hose tube at the desired mounting location. A button head bolt can then be inserted from inside of the tube liner and secured to the hose tube with a lock nut. Other means of fastening such as rivets, screws, or adhesives may also be used to affix the tube liner to the hose tube.

A plurality of liner segments can be affixed to the hose tube in the same manner.

Pull Weight Comparison

| Hose Tube Without Liner | Hose Tube With Liner |
|---|---|
| 4″ × 20′ stainless steel-35 lbs | 4″ × 20′ stainless steel - 15 lbs, |
| | reduced by 20 lbs; |
| 6″ × 10′ stainless steel-34 lbs; | 6″ × 10′ stainless steel -12 lbs, |
| | reduced by 22 lbs |
| 4″ × 20′ tiger flex-24 lbs; | 4″ × 20′ tiger flex - 10 lbs reduced |
| | by 241bs; |
| 4″ × 10′ food grade-22 lbs; | 4″ × 10″ food grade -8 lbs reduced |
| | by 17 lbs |

The pull weight comparison date shows a reduction in friction is evident when the hose tube liner is used in the hose tube.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

I claim:

1. A hose tube liner assembly for a trailer hose carrier tube comprising:
a trailer hose tube mounting to a trailer, said trailer hose tube comprising a material selected from steel, stainless steel, aluminum, corrugated polyvinyl chloride, and combinations thereof;
a hose having a high friction surface compared to said hose carrier tube;
a tube hose liner defining a sleeve having a surface of a lower friction compared to an interior surface of said trailer hose tube, said tube hose liner comprising a polymeric material or a coating; and
means for affixing said hose tube liner line to said interior surface of said hose carrier tube.
